(19) United States
(12) Patent Application Publication
(10) Pub. No.: US 2026/0211647 A1
(43) Pub. Date: Jul. 23, 2026

(54) Security Monitoring via Virtual Agents

(71) Applicant: Vault JS, Inc., Los Altos, CA (US)

(72) Inventors: Joshua Caleb Goodwin, Freemont, CA (US); Scott David Price, Chicago, IL (US); Joshua Ryan Manion, Los Altos, CA (US); Julie Kay Oberweis, Los Altos, CA (US); Mohammed Arshad, Chicago, IL (US)

(21) Appl. No.: 19/032,194

(22) Filed: Jan. 20, 2025

(51) Int. Cl. G06F 8/41

(52) U.S. Cl. CPC G06F 8/41

(57) ABSTRACT

A method, apparatus, and computer-readable medium are described in which a mobile application is modified by replacing third-party methods, interacting with data elements, with proxies of the third-party methods. The modified mobile application is executed by a virtual agent device. Interactions between the data elements and the proxy versions of the third-party methods are recorded and a linked list of interactions is generated. Based on the interactions, an alert dataset is generated identifying the data elements and the third-party methods interacting with them relative to a location on the mobile application. Further, web pages may be monitored based on known record, store, and send methods. The invocation of those methods may be monitored, the linked list of interactions generated, and an alert sent identifying data elements in the linked list that have been sent to a remote server.

### TECHNICAL FIELD

Aspects of the disclosure generally relate to management, regulation, control, profiling, identifying, fingerprinting, and/or auditing of user data collected while users interact with a deployed service. In particular, various aspects of the disclosure discuss features of an online privacy management system.

### BACKGROUND

Service providers continue to expand how their services are provided to their customers. Often, those services are provided via web pages and/or deployed mobile applications, e.g., executing on user's smartphones, tablets, and the like. In general, those service providers profit from both the services provided to their users as well as information of their users gathered by third-party applications executing on their websites and/or in their mobile applications. In many situations, the users accept the disclosure of their information to third parties as a condition of using the websites or mobile applications.

The third parties may provide their own services that may be of interest to the users including, for instance, social network services, password manager services, and marketing services. For the third-party services to operate in conjunction with the web pages and/or mobile applications, the third-party services execute in the background and monitor the user's interactions with user interface elements of the web pages or mobile applications. Third-party services do not discriminate on the information gathered in that those third-party services benefit from gathering more information about users by, for instance, serving the users advertisements related to their online activities via a current website being viewed or in a current mobile application or on other, unrelated websites or other mobile applications.

In order to protect users'privacy, government entities have enacted privacy protections. Those privacy protections include, for instance, the US Health Insurance Portability and Accountability Act of 1996 (HIPAA), the California Consumer Privacy Act as modified by the California Privacy Rights Act (CPRA) of January 2023, and the European Union's General Data Protection Regulation of 2016. Generally, these protections regulate the transfer of users'data from a provider of a service to other entities. The user's data may include Personal Identifiable Information (PII), Protected Health Information (PHI), and other information specifically associated with the individual. The types of information generally covered by PII and PHI include users'names, addresses, payment information, medical records, and/or other records that can be used to, their own or in combination with another piece of data, identify individuals. The information may have been created, used, or disclosed in the course of interacting with the providers' services. Because some privacy protections are regional (e.g., in a specific state or country), a need exists to be able to determine whether privacy violations occur when users are in a more restrictive jurisdiction.

Service providers bear the responsibility to ensure the security of their users' information. Because the goals of the providers of the third-party services are different (namely, wanting to gather as much of the users' information as possible), service providers need to restrict how those third-party services operate on the service providers' websites and/or in their mobile applications.

Service providers need to prevent third-party services from executing when a user is interacting with some areas of a website or mobile application while allowing execution of those third-party services when users are interacting with other areas of the website or mobile application.

Newer website designs that permit third-party services to persist across domains and the ability of users to interact with mobile applications while offline complicate the monitoring of third-party services. Further, deploying monitoring features to active web pages or active mobile applications available to users can still result in users'information being disclosed to third parties despite restrictions on the disclosures (e.g., restrictions on the tracking). Notification that the user's information has been disclosed to a third party is too late. Because third-party services are constantly trying to obtain user information and continually updating their software to circumvent service providers' efforts to restrict disclosure of users' information, a need exists for service providers to prevent disclosure of the users' information.

### SUMMARY

Aspects of the disclosure address one or more of the issues mentioned above by disclosing methods, computer-readable media, and apparatuses for an online privacy management system and related systems. In one example, a process may monitor known methods executing on a website, instantiate a virtual agent, and record those executions along with particular data elements related to those executions. In another example, a process may substitute third-party methods of a mobile application with proxy methods. A virtual agent may be instantiated to interact with data elements in the mobile application. Upon execution of the proxy methods, the executions may be recorded along with the particular data elements related to those executions. The recorded executions of the methods generate linked information that is then used to identify when and where the monitored methods were executed. The linked information is aggregated and parsed over time. The results may be in the form of an alert highlighting where users are tracked in violation of privacy regulations. In one or more examples, a virtual agent is instantiated and controlled to systematically access and interact with a website and/or mobile application. In other examples, interactions may be controlled based on traversing a tree diagraming the web page and/or application.

In one or more embodiments, a method may comprise receiving, from a storage, a network-connected software application; parsing the network-connected software application for methods and associated data elements; replacing the methods with proxy versions of the methods; assembling, based on the proxy versions of the methods, a replacement network-connected software application; instantiating, at a server, a virtual user agent configured to interact with data elements; interacting, via the virtual user agent, with the associated data elements of the replacement network-connected software application; receiving, based on the virtual user agent interacting with the associated data elements, notifications of execution of the proxy versions of the methods; storing the notifications including identifications of the proxy versions of the methods, data elements acted upon by the executed proxy versions of the methods, and results of the executed proxy versions of the methods; assembling, based on the stored notifications and the data elements, linked lists of the executed proxy versions of the methods, wherein at least some of the linked lists comprise sending associated data elements to a remote server; and generating, based on the linked lists, an alert for the network-connected software application with associated data elements sent to the remote server.

The network-connected software application comprises sections. The notifications may include identifications of the sections in which the proxy versions of the methods were executed. The generation of the alert may be based on the identification of the sections of the associated data elements.

The identification of the at least one of the sections may be less than all of the sections. The generation of the alert may be limited to the identified sections.

The alert may be segregated by third-party software development kits (SDKs).

The method may further include receiving a threshold, per section, of a quantity of data elements read per section. The generation of the alert may further include counting, per section, the quantity of associated data elements sent to the remote server; and determining, based on the counting, the quantity of associated data elements sent to the remote server satisfies the threshold.

The interacting may include specifying a geographic location, and the generating the alert being based on the geographic location.

The method may further include instantiating, at the server, a second virtual user agent configured to interact with the data elements, wherein the second virtual user agent specifies a second geographic location; and interacting, via the second virtual user agent, with the associated data elements of the replacement network-connected software application, with the generating the alert being based on the second geographic location.

The method of generating the alert may further comprise generating an alert data set by arranging the interactions into an ordered list of interactions and outputting the ordered list of interactions as a JavaScript Object Notation (JSON) file.

A first data element of the data elements may include an opt-out data element. The interacting with the associated data elements of the replacement network-connected software application may include causing the virtual user agent to modify a state of the opt-out data element. The generation of the alert may be further based on the modification of the state of the opt-out data element and subsequent notifications of executions of the proxy versions of the methods.

The method may be performed by an apparatus including one or more processors and memory-storing instructions. Further, the method may reside on a computer-readable medium that, when executed, causes one or more processors to perform the method.

This summary is provided to introduce a selection of concepts in a simplified form that are further described below in the detailed description. The summary is not intended to identify key features or essential features of the claimed subject matter, nor is it intended to be used to limit the scope of the claimed subject matter. Moreover, one or more of the steps and/or components described above may be optional or may be combined with other steps.

### BRIEF DESCRIPTION OF DRAWINGS

Systems and methods are illustrated by way of example and are not limited in the accompanying figures in which like reference numerals indicate similar elements and in which:

FIG. 1 shows an illustrative operating environment in which various aspects of the disclosure may be implemented;

FIG. 2 is an illustrative block diagram of workstations and servers that may be used to implement the processes and functions of certain aspects of the disclosure;

FIG. 3 is an illustrative arrangement of a virtual agent interacting with web pages and/or an executable application on a mobile device;

FIG. 4 is a process for a virtual agent to interact with a web page and record the execution of methods;

FIG. 5 is a process for a virtual agent to interact with a web page and record the execution of specific methods;

FIG. 6A is a dataset of monitored methods executing on web pages. FIG. 6B is a linked dataset of methods related to send methods;

FIG. 7 is a process for replacing methods of a mobile application with proxy versions of the methods, interacting with the modified mobile application, and recording the execution of the proxy methods;

FIGS. 8A, 8B, and 8C represent a proxy module replacing methods with proxy versions of the methods;

FIG. 9A is a dataset of monitored methods executing in a mobile application. FIG. 9B is a linked dataset of methods related to send methods;

FIG. 10 is a process for analyzing a nested set of aggregated results;

FIG. 11 is a diagram of methods available on one or more web pages;

FIG. 12 is a network diagram of data being shared by third parties based on connections between methods;

FIG. 13 is a network diagram of data being shared by third parties with less linking of data; and

FIG. 14 is a network diagram of data being shared by third parties despite the removal of some of the links in FIG. 12.

### DETAILED DESCRIPTION

In the following description of the various embodiments of the disclosure, reference is made to the accompanying drawings, which form a part hereof, and in which is shown by way of illustration, various embodiments in which the disclosure may be practiced. It is to be understood that other embodiments may be utilized and structural and functional modifications may be made.

Aspects of the disclosure relate to a process for instantiating a virtual agent for interacting with one or more web pages, monitoring the execution of methods on the one or more web pages, recording information related to the executed methods, analyzing the recorded information by constructing a linked list of send methods and working backward in time to associate earlier executed methods associated with the send methods. Additional aspects relate to a process for replacing methods with proxy methods in a mobile application, instantiating a virtual agent for interacting with the mobile application, monitoring the execution of proxy methods, recording information related to the executed proxy methods, analyzing the recorded information by constructing a linked list of proxy send methods and working backward in time to associate earlier executed proxy methods associated with the proxy send methods. The proxy versions of the methods generate information that is then used to identify when and where the proxy methods are executed.

The constructed linked list is a transformation of the virtual agent's interactions with the web pages or mobile application. As described herein, the constructed linked list is specific to internet-related issues related to tracking user data where the tracking of the underlying data is, in some situations, not supposed to occur. Because liability resides with the entity providing the web pages and mobile application and not the third parties, the entity providing the web pages and mobile application must ensure that personal user information (PII and/or PHI) is prevented from being sent to the third parties. As described herein, the improvements identified relate to technical improvements to how Internet-based communication methods are identified (in mobile applications), how virtual agent interactions with the methods are monitored, how the data associated with the monitoring of the methods is constructed into a linked list, and how the alerting is identified based on the constructed linked list.

The constructed linked list from the monitoring web page methods improves over conventional web page monitoring. Conventional web page monitoring relies on mapping send methods and the third parties associated with the send methods. Conventional web monitoring may rely solely on the presence of send methods without actual interaction data with those methods. Further, conventional monitoring is associated with web pages and does not address third-party tracking of data in deployable mobile applications. While send methods useable on web pages (e.g., via HTML5 and/or JavaScript) are well known, methods useable in mobile applications are not limited to those usable on web pages. This lack of limitation in usable send methods complicates the monitoring of applications as third-party developers can use new methods as well as obfuscate what data is monitored and sent to the third parties. This freedom and obfuscation frustrate conventional monitoring methods. One or more aspects of the disclosure enable improved identification of third-party monitoring and remediation by transforming a virtual agent's interactions with web pages or a mobile application into tracked data, associating the executed methods together by chaining the data elements together and alerting to send methods. The send methods may be further linked to respective third parties and the web pages and/or application modified to disrupt the chain of methods relating to the sending of the user data.

The results of the construction of the linked lists may be in the form of an alert highlighting where users are tracked in violation of privacy regulations. In one or more examples, a virtual agent is instantiated and controlled to systematically access and interact with the monitored website and/or the monitored mobile application.

In general, aspects of the disclosure are capable of other embodiments and of being practiced or being carried out in various ways. Also, it is to be understood that the phraseology and terminology used herein are for the purpose of description and should not be regarded as limiting. Rather, the phrases and terms used herein are to be given their broadest interpretation and meaning. Any sequence of computer-implementable instructions described in this disclosure may be considered to be an “algorithm” as those instructions are intended to solve one or more classes of problems or to perform one or more computations. While various directional arrows are shown in the figures of this disclosure, the directional arrows are not intended to be limiting to the extent that bi-directional communications are excluded. Rather, the directional arrows are to show a general flow of steps and not the unidirectional movement of information, signals, and/or power. In the entire specification, when an element is referred to as “comprising” or “including” another element, the element should not be understood as excluding other elements so long as there is no special conflicting description, and the element may include at least one other element. In addition, the terms “unit” and “module”, for example, may refer to a component that exerts at least one function or operation, and may be realized in hardware or software, or may be realized by a combination of hardware and software. Throughout the specification, the expression “at least one of a, b, and c” may include ‘a only’, ‘b only’, ‘c only’, ‘a and b’, ‘a and c’, ‘b and c’, and/or ‘all of a, b, and c’. The expression “at least one of a, b, or c” may include ‘a only’, ‘b only’, ‘c only’, ‘a and b’, ‘a and c’, ‘b and c’, and/or ‘all of a, b, and c’. Similarly, the expression “one or more of a, b, and c” may include ‘a only’, ‘b only’, ‘c only’, ‘a and b’, ‘a and c’, ‘b and c’, and/or ‘all of a, b, and c’. The expression “one or more of a, b, or c” may include ‘a only’, ‘b only’, ‘c only’, ‘a and b’, ‘a and c’, ‘b and c’, and/or ‘all of a, b, and c’.

It is noted that various connections between elements are discussed in the following description. It is noted that these connections are general and, unless specified otherwise, may be direct or indirect, and that the specification is not intended to be limiting in this respect.

As described herein, thresholds are referred to as being “satisfied” to generally encompass situations involving thresholds above increasing values as well as encompass situations involving thresholds below decreasing values. The term “satisfied” is used with thresholds to address when values have passed a threshold and then approaching the threshold from an opposite side using terms such as “greater than”, “greater than or equal to”, “less than”, and “less than or equal to” can add ambiguity where a value repeated crosses a threshold.

### Identifying Tracking of User Information in Web Pages

Web pages are generally written in Hypertext Markup Language (HTML). They are written using HTML elements that include “tags” surrounded by angle brackets; information in the tag tells the web browser how to interpret the HTML element (e.g., as text, for insertion of an image into the web page, for running a script, etc.). These tags can, among other things, include or load scripts in languages such as JavaScript™.

Web analytics is a field in which data about customers (e.g., customer behavior, customer location, etc.) is collected and analyzed for a variety of purposes. To obtain data for web analytics, a population of users visits a web page and/or starts an application that causes certain program instructions to be executed. Usually, data is collected for web analytics purposes through a variety of mechanisms, including the setting of a cookie and/or by running scripts in the HTML document. The scripts may perform a variety of functions, including grabbing variables from the document object model (DOM) and/or sending back an image request to a data collection server either internally or externally hosted.

The program instructions for web analytics are generally authored and run by a variety of vendors, including Omniture™, Google™, Yahoo™, and Webtrends™, among others, in order to be able to capture data such as web page load times, “mouse-overs” (i.e., moving a mouse over a particular object on the web page), and the page requestor's IP address. A medium-complexity web page may include 5-10 tags with a reference to computer scripts that are run on servers managed by different vendors.

Some web analytics tools use the HTML image element and/or JavaScript to assist in collecting analytics data. An analytics data transmission may be masked as an image element that does not add the image element to the web page's DOM. Instead, the image element may be for a one-pixel-by-one-pixel transparent image by the analytics vendor for the purposes of collecting data related to the web page visitor. For example, the “src” attribute may be set to a URL with an appended string of parameter name-value pairs (e.g., www.hostname.com/theImage.gif? data=something&data2=someMoreData). Once the “src” attribute is set, the browser may attempt to locate and retrieve the image at the URL location. In doing so, the analytics data may be obtained at the remote server as these name-value pairs. This is one method frequently used by web analytics vendors for collecting data.

Some companies may outsource their web analytics to one or more third-party vendors (e.g., web analytics vendors, voice of consumer (VOC), ad servers, testing solutions, targeting tools, pay-per-click (PPC) tools, affiliate tracking, etc.) that specialize in web analytic, web advertising, and other web-related services. Meanwhile, these third-party vendors may contract/work with one or more fourth-party vendors to assist in collecting data, displaying/selecting advertising images, analyzing collected data, etc. For example, a fourth-party vendor may be executing code on the companies'web pages or collecting analytics data from the web pages. This fourth-party vendor may be unknown to the website owner or might not be an industry-verified vendor. Some fourth-party vendors might not respect DNT (Do-Not-Track) Headers, unbeknownst to the website owner/company. In some cases, the fourth-party vendor may even share the information collected about visitors with fifth-party vendors, again unbeknownst to the website owner/company. As such, data may be collected and distributed from the website to domains and vendors unknown to the website administrator. Privacy and other issues (e.g., technical issues) may arise in regulating, controlling, and/or auditing the dissemination of the data. The disclosure attempts to provide an online privacy management system that, among other things, permits users (e.g., Chief Privacy Officers of a company, etc.) to better control/regulate/manage consumer data and privacy.

In the field of web analytics, website owners and/or third-party vendors collect data when users visit websites. Such data may include information about visitors (e.g., visitor names, visitor ages, visitor demographics, etc.), where visitors are located, how well the website performs (e.g., page load times), and how a visitor interacts with the website (e.g., mouse-overs, mouse-clicks, and other events indicating visitor behavior). Tags may be placed on web pages to facilitate collection of the data. Once collected, the data may be used for various purposes, such as marketing. For example, a marketing team may use web analytics to determine how to improve a website to increase traffic and/or generate more sales.

As mobile devices (e.g., smartphones, tablets, etc.) become increasingly popular, more and more organizations (e.g., businesses) are using mobile applications to connect with people (e.g., customers, users, etc.). Mobile applications are applications designed to run on mobile devices. Mobile devices typically have less processing power and smaller screens than other computing devices, and therefore, have specially-designed operating systems for running specially-designed applications. Examples of operating systems for mobile devices include ANDROID (provided by Google) and iOS (provided by Apple).

As mentioned, mobile applications, like web pages, are used to connect organizations with people. As such, organizations may desire to collect analytics similar to web analytics but related to the use of mobile applications. For example, organizations may be interested in obtaining information about users of their mobile applications (e.g., user names, user ages, user demographics, etc.), where users are located, how well their mobile applications perform (e.g., whether a mobile application crashes or freezes, how long a mobile application takes to provide information or images, etc.), and how users interact with their mobile applications (e.g., where users click, where users move their mouse, etc.). Such analytics may be obtained by placing code in mobile applications to capture data and transmit the data to a backend system.

In another embodiment, a privacy management system (PMS) is also disclosed for a Chief Privacy Officer (CPO) or other user to use in, among other things, monitoring and/or controlling in real-time the flow of data (e.g., outflow) about the user and his/her online experience. The PMS may provide a dashboard displaying a whitelist and/or blacklist indicating what destinations/sources are blocked or allowed. The dashboard may also include settings that a user can set to create rules for blocking private information from being transmitted as analytics data.

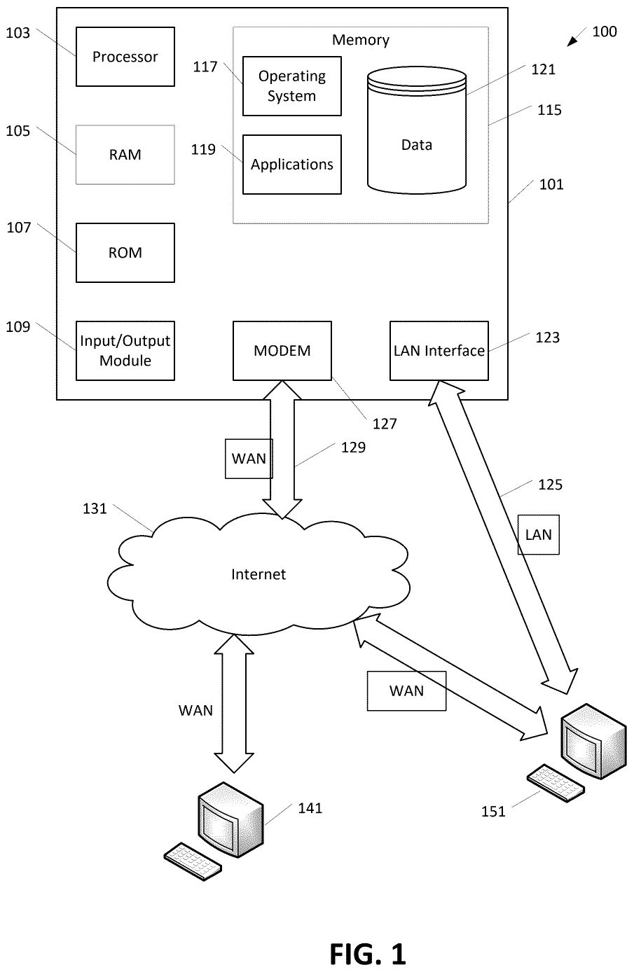

FIG. 1 describes, among other things, an illustrative operating environment in which various aspects of the disclosure may be implemented. FIG. 1 illustrates a block diagram of a tag/content manager 101 (e.g., a computer server) in communication system 100 that may be used according to an illustrative embodiment of the disclosure. The manager 101 may have a processor 103 for controlling the overall operation of the manager 101 and its associated components, including RAM 105, ROM 107, input/output module 109, and memory 115.

I/O 109 may include a microphone, keypad, touch screen, and/or stylus through which a user of device 101 may provide input, and may also include one or more of a speaker for providing audio output and a video display device for providing textual, audiovisual, and/or graphical output. Software may be stored within memory 115 to provide instructions to processor 103 for enabling manager 101 to perform various functions. For example, memory 115 may store software used by the manager 101, such as an operating system 117, application programs 119, and an associated database 121. Processor 103 and its associated components may allow the manager 101 to run a series of computer-readable instructions to deploy program instructions according to the type of request that the manager receives. For instance, if a client requests that program instructions for capturing mouse movements for complete session replay be executed, manager 101 may transmit the appropriate instructions to a user's computer when that user visits the client's website.

The manager 101 may operate in a networked environment supporting connections to one or more remote computers, such as terminals 141 and 151. The terminals 141 and 151 may be personal computers or servers that include many or all of the elements described above relative to the manager 101. Alternatively, terminal 141 and/or 151 may be part of a “cloud” computing environment located with or remote from manager 101 and accessed by manager 101. The network connections depicted in FIG. 1 include a local area network (LAN) 125 and a wide area network (WAN) 129, but may also include other networks. When used in a LAN networking environment, the manager 101 is connected to the LAN 125 through a network interface or adapter 123. When used in a WAN networking environment, the server 101 may include a modem 127 or other means for establishing communications over the WAN 129, such as the Internet 131. It will be appreciated that the network connections shown are illustrative and other means of establishing a communications link between the computers may be used. The existence of any of various well-known protocols such as TCP/IP, Ethernet, FTP, HTTP, and the like is presumed.

Additionally, an application program 119 used by the manager 101 according to an illustrative embodiment of the disclosure may include computer executable instructions for invoking functionality related to delivering program instructions and/or content. Computing device 101 and/or terminals 141 or 151 may also be mobile terminals including various other components, such as a battery, speaker, and antennas (not shown).

The disclosure is operational with numerous other general-purpose or special-purpose computing system environments or configurations. Examples of well-known computing systems, environments, and/or configurations that may be suitable for use with the disclosure include but are not limited to, personal computers, server computers, hand-held or laptop devices, multiprocessor systems, microprocessor-based systems, set-top boxes, programmable consumer electronics, network PCs, minicomputers, mainframe computers, and distributed computing environments that include any of the above systems or devices, and the like.

The disclosure may be described in the general context of computer-executable instructions, such as program modules, being executed by a computer. Generally, program modules include routines, programs, objects, components, data structures, etc. that perform particular tasks or implement particular abstract data types. The disclosure may also be practiced in distributed computing environments where tasks are performed by remote processing devices that are linked through a communications network. In a distributed computing environment, program modules may be located in both local and remote computer storage media including memory storage devices.

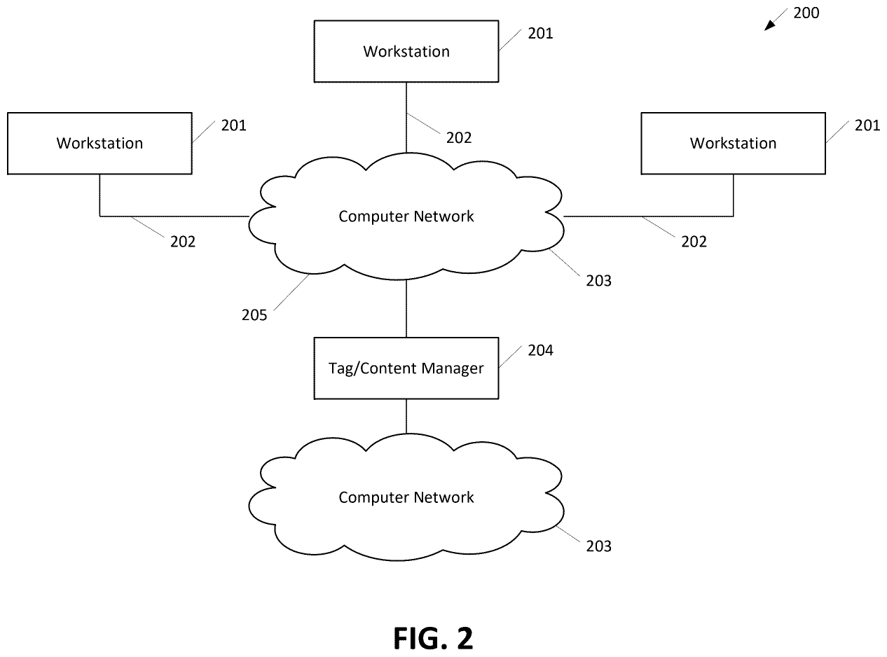

Referring to FIG. 2, the figure describes an illustrative block diagram of workstations and servers that may be used to implement the processes and functions of certain aspects of the disclosure. FIG. 2 describes an illustrative system 200 for implementing methods according to the present disclosure is shown. As illustrated, system 200 may include one or more workstations 201.

Workstations 201 may be local or remote and are connected by one or more communications links 202 to a computer network 203 that is linked via communications links 205 to tag/content manager server 204. In certain embodiments, workstations 201 may be different storage/computing devices for storing and delivering client-specific program instructions, or in other embodiments workstations 201 may be user terminals that are used to access a client website and/or execute a client-specific application. In system 200, tag/content manager server 204 may be any suitable server, processor, computer, data processing device, or combination of the same. Throughout this disclosure, tag/content manager server 204 will be used to reference both the server/terminal that stores program instructions for tag/content management and the tag/content management program instructions themselves.

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and tag/content manager server 204, such as network links, dial-up links, wireless links, hard-wired links, etc.

The steps that follow in the Figures may be implemented by one or more of the components in FIGS. 1 and 2 and/or other components, including other computing devices.

In one or more examples, a method accesses a website and interacts with it. During the interaction, the method inventories everything on the site by, for example, performing an audit of all information regarding how the site operates. The information may include one or more of the technologies used, cookies, and third-party methods executing on the website. In one or more examples, the method collects how data is exchanged and or tracked by third-party methods executing on the website. In one or more examples, the third-party methods may comprise proprietary vendor libraries that may include multiple methods. The method monitors what data is collected and by which third-party method is associated with a vendor's library. The method may detect malicious behavior of the third-party methods, anomalies associated with the third-party methods, domains associated with where the data is flowing, and the like. In one or more examples, the method may gather some or all of the data associated with a user's experience.

In one or more examples, the process may operate by analyzing a website or mobile application repeatedly and/or may perform the analysis in stages. With respect to the staged approach, a first execution of the website or mobile application may include the creation of a fingerprint for each page (or section of a mobile application) and then storing the fingerprint. During subsequent stages, a fingerprint of a web page may be compared with the previously stored fingerprints of pages to determine whether a current page has been previously reviewed. If the current page has been previously reviewed, then it may be skipped in the process and advance to the next page of the website or section of the mobile application.

The following is a sample of pseudo-code that, when executed, helps identify items displayed on a web page as well as scripts executing during the display of the web page:
function collectSignals( ) {
   var s={};
   var ft=initFt(s);
   var d=new Date( );
   s.D9_101=window.screen ? window.screen.width:undefined;
   s.D9_102=window.screen ? window.screen.height:undefined;
   s.D9_103=window.devicePixelRatio;
   s.D9_110=d.getTime( );
   s.D9_111=d.getTimezoneOffset( );
   s.D9_120=navigator.platform;
   s.D9_121=navigator.language||navigator.browserLanguage;
   s.D9_122=navigator.appCodeName;
   s.D9_123=navigator.maxTouchPoints||0;
   var m=ft.isM(s.D9_120, s.D9_123);
   s.D9_130=ft.flashVersion(m);
   s.D9_131=ft.acrobatVersion(m);
   s.D9_132=ft.silverlightVersion(m);
   s.D9_133=ft.getMimeTypes(m);
   s.D9_134=ft.getPlugins(m);
   s.D9_140=ft.encodeURIComponent(ft.location( ));
   s.D9_141=ft.encodeURIComponent(ft.referrer( ));
   s.D9_150=ft.bh64( );
   s.d9_151=ft.bh( );
   return s
}

Often, websites place cookies in a browser's local storage to help track users' activities across a website and between websites. For third-party vendors who track users via cookies, the conventional approach monitors the placement and subsequent access to the cookies. However, more recently, some third-party vendors have started tracking users via other approaches beyond the placement and retrieval of cookies. One or more aspects of the disclosed process monitor those non-cookie tracking situations. In one or more examples, the system evaluates a website or mobile application in two phases. In a first phase, the system parses a website or mobile application, identifies third-party methods accessing data elements, and wraps those third-party methods in proxy versions of the methods. In a second phase, a virtual agent is instantiated and interacts with the website or mobile application.

The proxy versions of the methods, when executed, perform as specified by the third-party vendor and also tag the executions of the methods. The tags may include a variety of information including the data element accessed by the third-party method, the identification of the web page with that data element where the third-party method executed (and/or a section of a mobile application with the data element where the third-party method executed), and the third-party method that accessed the data element. As explained herein, the disclosed process improves over single-step, conventional approaches in that the disclosed process monitors the actual execution of a virtual agent's interaction with a website and or mobile application. By monitoring the actual execution of the user's interaction and how data elements are monitored by the third-party methods, the disclosed process is able to circumvent various approaches used by third-party vendors to obfuscate their tracking data elements. For example, by identifying which data elements are tracked, the disclosed system may be able to track the execution of third-party methods across multiple web pages or sections of an application where an immediate sending of the tracker data does not incur until a later time. Further, by repeatedly executing the disclosed method at different times and by setting the virtual agent's location to various geographic locations, the disclosed process is able to detect time-specific and/or geographic location-specific monitoring of data elements.

Conventional approaches may parse a website and look for specific query strings. A disadvantage of that conventional approach is that by ignoring the underlying executing code, that conventional approach would miss tracking that is embedded in the code itself. For example, a third-party vendor that collects data obfuscates that data before sending it as a query parameter. If the data is not deobfuscated, then it would be difficult to appreciate what was collected. As described herein, by linking the send methods and previous methods and the data linking each of the methods together, the system traces the third-party vendor collecting data, obfuscating the data, and sending the obfuscated data. The need to deobfuscate the data is avoided.

In one or more examples, the process may count the quantities of third-party method executions over time. For example, third-party methods that record and store data entered in a first set of data elements may execute on a first page of the website. However, corresponding third-party methods that send that store data to the third-party vendor may only execute at a later time of day and/or may only execute when the user has accessed a different web page. These delayed executions of the third-party methods sending tracked information to the third party are often undetectable by conventional monitoring systems. As disclosed herein, the method may monitor events associated with each of the recording, storing, and/or sending of user interactions with a website or mobile application. Once those events have been received, they may be aggregated together into linked lists of executed methods. The aggregated data set may be parsed to detect a combination of two or three methods (e.g., record and store; store and send; record and send; and/or record, store, and send) regardless of how close or far in time the executions of those methods occur from each other. In relevant part, by parsing the aggregated data set over time after multiple executions of methods have been monitored, the disclosed method may be able to detect nested relationships spanning hundreds or thousands of separate executions of methods across multiple websites. By splitting the monitoring process into two phases, the approach described herein provides superior tracking monitoring compared to conventional tracking monitoring approaches.

In one or more examples, jurisdictions require opt-out selections to be processed immediately and respected. A website provider or mobile application provider may act on the opt-out selections immediately and thus comply with the jurisdictions' requirements. However, third-party methods may ignore the opt-out selections and continue collecting user data. One or more aspects of the disclosed system may include identifying opt-out data elements during the first phase and interacting with those data elements in the second phase. Based on the execution of the third-party methods after an opt-out data element has been selected, the disclosed process may help identify those third-party methods in violation of the jurisdictional opt-out requirements.

In one or more examples, the disclosed process analyzes tracking events in the aggregate as compared to triggering solely on individual tracking events. The disclosed process may monitor tracking by identifying, for a given data element, how many third-party methods are monitoring that data element on a given page. The disclosed process monitors how code executes on a web page and/or mobile application and the associated application programming interface (API) calls and responses. In some examples to reduce processing overhead per web page, some web page providers may restrict third-party methods from executing more than a given number of APIs per web page (e.g., no more than five). Attempting to count how many separate API executions per web page is beyond the conventional monitoring approaches of privacy tracking systems. By the disclosed process' monitoring of code executions, while a virtual user agent interacts with web pages or a mobile application, an aggregated dataset of those executions may be compiled and parsed to determine how many API executions occur on a given web page. The website owner may then modify how those third-party APIs are called on their web page.

An issue with executable scripts running on web pages is that the executed scripts run in the background. For conventional monitoring systems that only monitor user interface elements, those conventional approaches miss the scripts running in the background. By replacing third-party methods with proxies of those third-party methods, this disclosed system allows for monitoring of those individual scripts beyond conventional systems. Further, by monitoring executions of scripts and aggregating the tracking of their executions, the system is able to identify those scripts that, for example, execute only once every 15 seconds. Conventional approaches monitoring only user interface elements miss these delayed executions of scripts if not the execution of scripts at all.

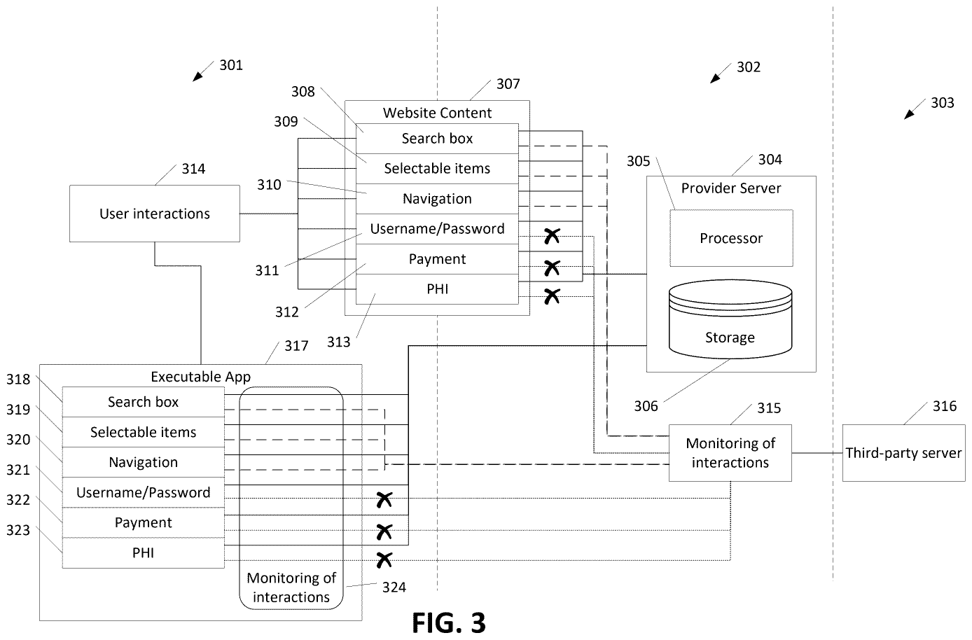

FIG. 3 is an illustrative arrangement of user interactions with web pages and/or executable applications on a mobile device. FIG. 3 includes three environments: a user interaction space 301, a provider server space 302, and a third-party server space 303. The provider server space 302 includes a provider server 304 that includes one or more processors 305 and a storage 306. The provider server space 302 hosts one or more websites that are provided to end users. In FIG. 3, a website is provided to a user with the website's content shown as website content 307. The website content 307 is shown bridging the user interaction space 301 and the provider server space 302 as the website content 307 may exist in either and/or some content may exist in both spaces. For instance, the user's browser may include some client-side scripting of content while the provider server 304 (possibly including one or more edge servers) may include server-side scripting of content.

The website content 307 may include a search box 308, selectable items 309, navigation controls 310, one or more regions 311 for entering a username and/or password, one or more regions 312 for entering payment information, and a PHI region 313. User interactions 314 with the website content 307 are provided to the provider server 304. The processor 305 in the storage 306 of the provider server 304 receives the website content and performs further operations relevant to the user interactions 314 (e.g., searching, selecting, navigating, providing and/or updating usernames or passwords, making payments, or providing and/or interacting with PHI information, and other interactions).

Third-party scripts running in the website content 307 allow one or more third parties to monitor the user interactions 314 with the website content 307. As shown in FIG. 3, the third parties'monitoring of interactions 315 may obtain information from the user interactions 314 with any of the website content 307. The monitoring of interactions 315 may be then forwarded to the third-party servers 316. While the monitoring of the user interactions 314 with the search box 308, selectable items 309, and navigation controls 310 and/or interfaces is generally acceptable, the monitoring of user interactions 314 with any of the username/password 311, payment 312, and/or PHI 313 regions is problematic. The duty to police the third-party monitoring of interactions 315 resides with the provider and not always with the third parties. For instance, user interactions with various content may be provided to third-party servers identifying, for example, the user's identity, the user's interactions with the web page, the user's location, and/or the name of the web page.

In addition to a user being able to interact with website content 307, the user may also interact with an executable application installed on the user's mobile device. As shown in FIG. 3, executable app 317 may include interaction regions and/or capabilities similar to those provided in the website content 307. For instance, the user may interact with a search box 318, selectable items 319, navigation 320, provide and/or update a username/password 321, provide and/or update payment information 322, provide or update PHI information 323, and/or other related interactions. Third parties may monitor the user interactions 314 with the executable app 317 once the interactions are received at the server (e.g., via the monitoring of interactions 315) and/or directly in the executable app 317 based on third-party software development kits (SDKs) and their associated libraries being integrated into the executable app 317 (. As shown by the monitoring of interactions 324 functionality integrated into the executable app 317). For instance, user interactions with various content may be provided to third-party servers identifying, for example, the user's identity, the user's interactions with the application, the user's location, and/or the name of the section of the application. While the monitoring of user interactions with the search box 318, selectable items 319, and navigation regions 320 are generally acceptable, the third-party monitoring of the user's interactions with the username/password user interface 321, the payment user interface 322, and/or the PHI user interface 323 is generally not permitted. One or more aspects of this disclosure relate to identifying, and thus preventing, previously unidentifiable third-party monitoring of PII and/or PHI information.

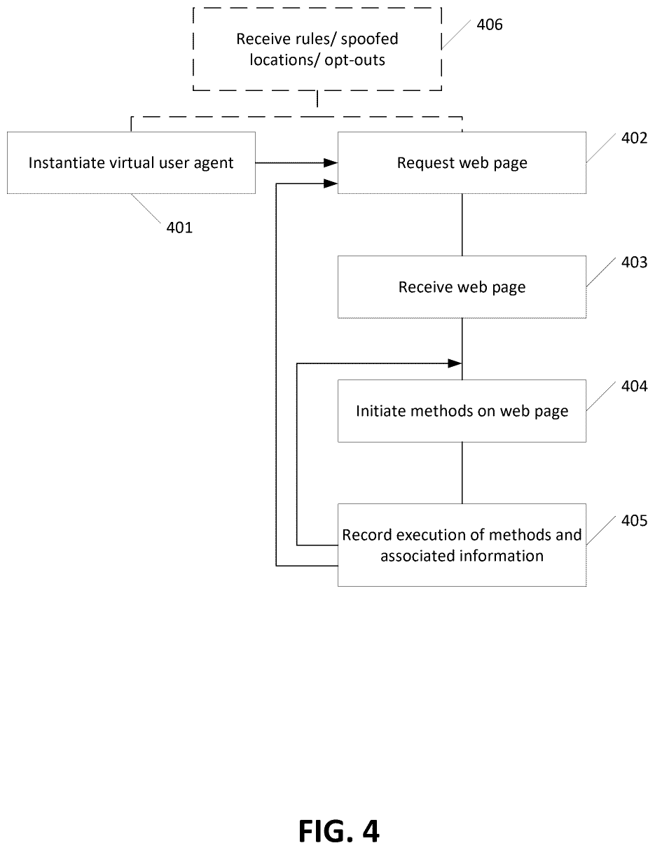

FIG. 4 is a process for monitoring an agent's interactions with a web page. Three types of methods are of interest in web page monitoring of methods: record methods, store methods, and send methods. These methods are known via standard HTML5 and other web-acceptable protocols including JavaScript. The process of FIG. 4 may be executed on the service provider's server and/or servers. In step 401, a virtual user agent is instantiated. The virtual user agent requests the web page in step 402. In step 403, the web page is received. The web page may come directly from a service provider's server and/or from a combination of servers. For example, images and/or other content may be pulled from third-party servers and become an executable part of the web page.

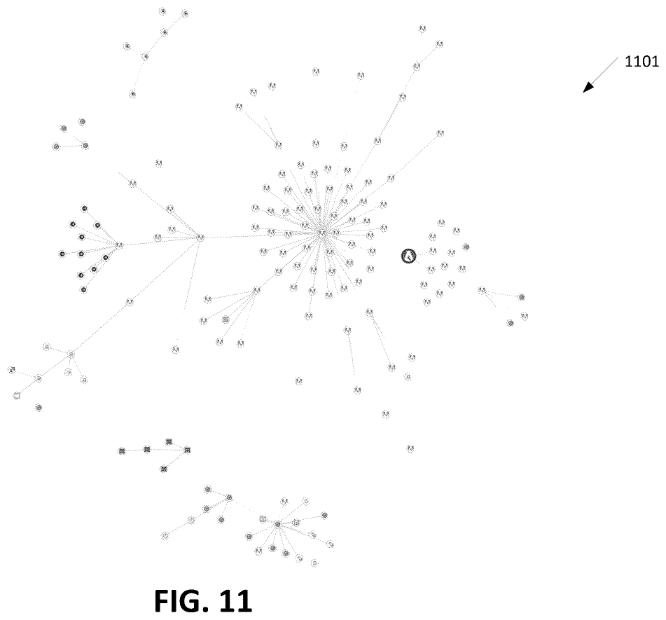

To assist the virtual user agent, the web page may be parsed to identify one or more ordered interactions to be performed by the virtual user agent. An example of a parsed web page is shown in FIG. 11. The parsing may be performed once all web pages are received or dynamically as the web pages are being received. Further, the parsing process may include adding an identifier representing each data element to assist in the mapping of data elements as appearing on and between web pages.

The system creates a tree of data elements from the relationships of the data elements between each other and to each web page. The tree created may comprise a linked list of elements in the form of a source-target edge table. Additionally or alternatively, the tree created may comprise a graphical tree representing the relationships. In an additional example, the graphical tree may be generated from the source-target edge table. Additionally or alternatively, the tree may comprise a JSON file identifying the relationships. Further, the created tree may be stored.

In step 404, the virtual user agent interacts with data elements on the web page including, for instance, adding data to particular input fields, selecting options, navigating the user interface, and clicking various buttons. In one or more instances, those virtual user agent interactions with the data elements initiate methods on the web page in step 404. In step 405, the system records the execution of the methods, the data elements that the methods are acting on, and the destinations of the executed methods. For instance, where the virtual user agent enters data into a name field and a method is monitoring the data entered into that name field, the system records the execution of that record method in step 405. The recorded information may include an identification of the name field, an identification of the record method, the web page containing the name field, and a location of where the data in the name field was recorded by the method (e.g., as a variable, field, or flag, or other known datatype for recording user inputs).

Another method that may execute and whose information is stored in step 405 is a store method. The store method may operate based on the existence of data in the location recorded by the record method. Upon operation of the store method, the system records various information on the execution of the store method. For instance, the system may record an identification of the location acted upon by the store method (e.g., the variable, field, flag, or other datatypes, or the like), an identification of the store method, the web page or SDK associated with the store method, and the location of where the data was stored by the method (e.g., as a cookie, local storage session information, an index database, and/or other places where information is stored locally by a browser).

A further method that may execute and whose information is stored in step 405 is a send method. The send method may operate based on the existence of data in the location stored by the store method. Upon operation of the send method, the system records various information on the execution of the store method. For instance, the system may record an identification of the location of the data sent by the send method (e.g., the cookie, the local storage session information, the index database, and/or other places where information was stored locally by the browser and sent by the send method), an identification of the send method, the web page or SDK associated with the send method, and the location of where the data was sent by the method (e.g., an IP address or the like).

The virtual user agent may continue interacting with the data elements on the page as shown by the directional arrow from step 405 to step 404. The virtual user agent may continue to request additional web pages and interact with the data elements on them as shown by the directional arrow from step 405 to step 402. Additionally or alternatively, the same virtual user agent may interact with the subsequent web pages or another virtual user agent may be instantiated to interact with data elements on other web pages.

Step 406 shown in dashed lines refers to the initial information received for how the pages are requested and/or how the virtual user agent interacts with the pages. For instance, the initial information may include geographic identification information to be used when requesting the web page in step 402. The web page may be requested a first time with a first geographical identification and a second time with a second geographical identification such that one of two geographical identifications may relate to a location without privacy restrictions and the other may relate to a location with privacy restrictions. The requesting of different geographical locations may be referred to as spoofing one's location. Based on the two different geographical identifications, the system is able to determine whether the third-party methods distinguish between the two different types of restrictions based on the location. If the third-party methods do not distinguish between the two locations, additional restrictions may be added to the web page to restrict how the page operates based on the different geographic locations.

The information received in step 406 may further include how a browser is supposed to identify itself when requesting the web page in step 402. For instance, the browser may identify itself as Microsoft Edge (from the Microsoft Corporation), Google Chrome (from Google LLC), or another browser and, if desired, a version number of the browser. Identifying itself as different types of browsers enables the system to test the web page and how the third-party methods interact with the data elements based on the different browser identifications.

The information received in step 406 may further identify a time or date to test the web page. For instance, some third-party methods may restrict themselves to only operate on certain days or during certain time windows to gather information. By identifying the day and/or time to be running, the system may better determine what methods are operating on different dates and/or at different times.

The information received in step 406 may further include rules to be applied by the virtual user agent. The rules may include information to be entered by the virtual user agent and/or requirements regarding how many times data elements are to be interacted with per page. The quantity of interactions may be relevant as the service provider may limit the quantity of third-party methods acting on the page to a predetermined threshold (e.g., 5 or fewer interactions). The virtual user agent may interact with data elements individually past that threshold or collectively past the threshold. Those interactions may invoke the third-party methods, whose activities are recorded in step 405. Those activities per page exceeding the threshold may then be identified for modifying the web page to restrict those activities exceeding the threshold.

Further, the information provided in step 406 may include instructions for the virtual user agent to opt-out of tracking. Third-party methods are supposed to adhere to a user's request to opt-out of tracking but do not consistently do so. The virtual user agent may opt-out of tracking and that opt-out is stored in the information recorded in step 405. While third-party methods that operate prior to the opt-out may be acceptable, third-party methods that operate after the opt-out need to be restricted from operating. Based on information recorded in step 405, the web page may be modified to require the third-party methods of the page to respect a user's opt-out choice. The web page may be modified to remove the third-party methods entirely or may be modified to include additional instructions that monitor the opt-out selection and prevent the execution of the methods when the user has opted out of tracking.

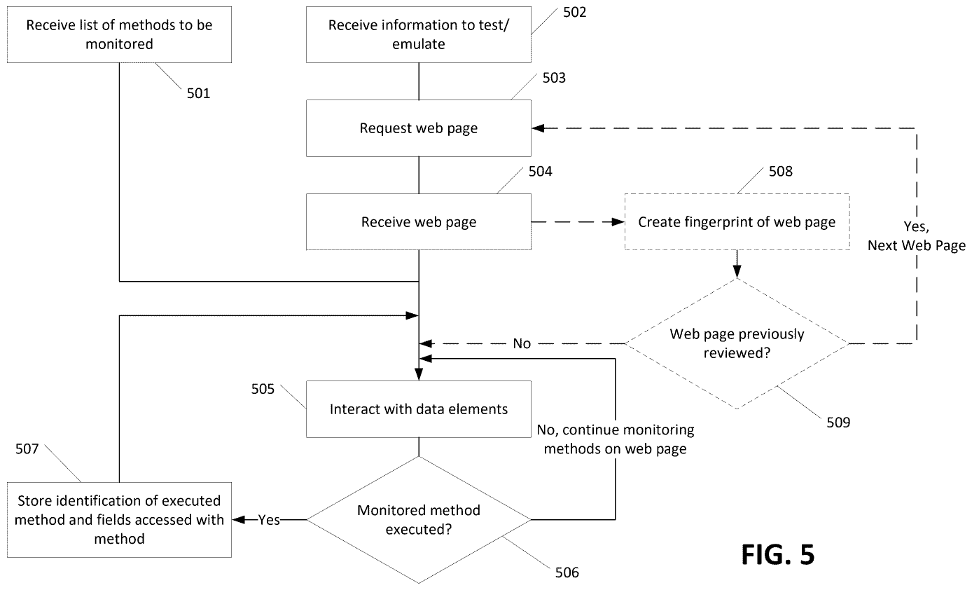

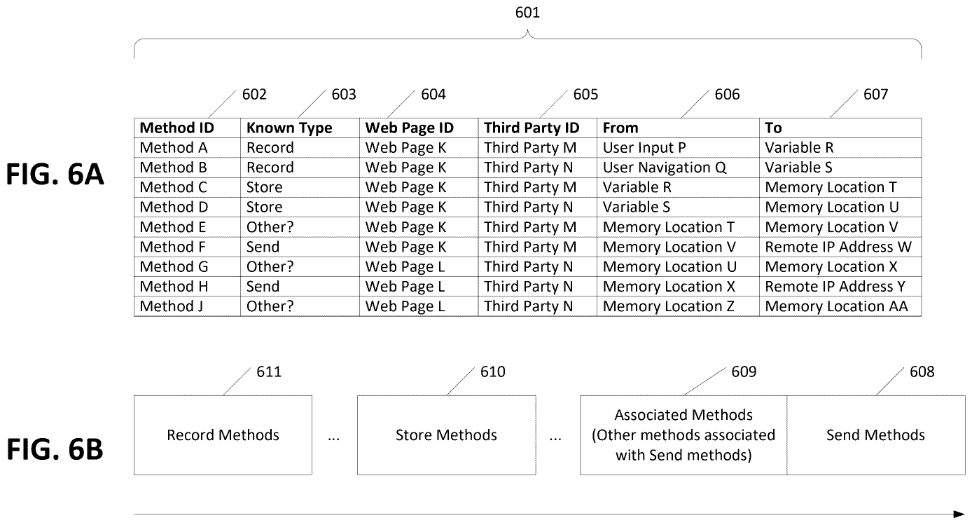

FIG. 5 is a process for a virtual agent to interact with a web page and record the execution of specific methods. In step 501, a list of specific methods to be monitored is received. The list of specific methods may be limited to specific recording methods, storing methods, and sending methods. In step 502, information relevant to the testing of the web pages may be similar to the testing instructions/parameters/identification information described above with respect to step 406. In step 503, a web page is requested by a virtual user agent (separate from or part of step 502). In step 504, the web page is received based on the request from step 503 and the information from step 502. In step 505, the virtual user agent interacts with the data elements, thereby invoking the execution of the third-party methods monitoring the data elements on the web page. In step 506, the system determines whether one of the methods from the list provided in step 501 has been executed. If no, then the system continues to monitor for the methods. If the system determines in step 506 that an identified method has been executed, the system stores the identification of the executed method in step 507 and the fields associated with the executed method. The stored fields are described herein with respect to FIG. 6A. The virtual user agent continues to interact with the data elements in step 505 and the system continues monitoring for the execution of the methods in step 506.

FIG. 5 includes an optional additional process where, in step 508, the system creates a fingerprint of the web page. For instance, the pseudo-code for the CollectSignals function described above may be used. The system determines in step 509 whether that web page was previously reviewed. If the web page has not been previously reviewed, then the virtual user agent interacts with the data elements as shown in step 505. If the system determines that the web page has been previously reviewed (e.g., by its fingerprint matching that of a previously reviewed web page), the system requests the next web page in step 503.

FIG. 6A is a dataset of monitored methods executing on web pages. FIG. 6A includes a list 601 with methods column 602, known types column 603, a web page identification column 605, a third party identification column 605 associated with the source of the third-party methods, a From column 606 identifying the data element that invoked the method, and a To column 607 identifying the output of the method. As shown in FIG. 6A, method A is a record method that is executed when web page K is displayed. The method A is from third-party M and monitors user input P. The user input P is recorded as variable R. Method B is a record method that is executed when web page K is displayed. The method B is from third-party N and monitors user navigation Q. The user navigation Q is recorded as variable S. Method C is a store method that is executed when web page K is displayed. The method C is from third-party M and monitors variable R. The method C stores variable R in memory location T. The memory location T may be a cookie, index DB, or other browser-based storage.

Method D is a store method that is executed when web page K is displayed. The method D is from third-party N and monitors variable S. The method D stores the variable S in memory location U. Method E is another type of method (identified in list 601 as “other?”). Method E executes when web page K is displayed. Method E is from third party M. It performs an operation on the data at memory location T and stores the results in memory location V. Method F is a send method that operates when web page K is displayed. Method F is from third party M and sends the content of memory location V to remote IP address W. Method G, like method E, is identified as an “other?” method. It operates when a different web page L is displayed. Method G is from third party N and operates on the data at memory location U and stores it at memory location X. Method H is a send method and operates when web page L is displayed. Method H is from third party N. Method H sends the content of memory location X to remote IP address Y. Method J is also an “other?” method and operates when web page L is displayed. Method J is also from third-party N. Method J operates on data stored at memory location Z and stores the result at memory location AA.

The data from list 601 may be combined into a linked list. FIG. 6B shows an example of the linked list. The record methods 611 are identified at an earlier location in the linked list, the related store methods 610 are identified at a later location in the linked list, the other methods that are not record and store methods are further provided in the linked list, and the send methods 608 are at the end of each linked list. The relative importance of the record methods 611, store methods 610, associated methods 609, and send methods 608 is based on the closeness a method is to the end of the linked lists. In particular, the third-party methods are relevant primarily because of tracking of user data. While the third-party methods may record and store user data, the relevance of that tracking is limited where the user data is never sent out of the system. In effect, the third-party methods may be effectively policing themselves where no user data is being sent to a remote IP address. However, concentrating solely on the send methods fails to account for what specific user data is being sent. Accordingly, the linked lists of FIG. 6B may be analyzed starting with the send methods 608 and tracing the upstream methods (associated method 609, store methods 610, and record methods 611) to the relevant user information being tracked by the original record methods 611.

The rules creating the linked list of FIG. 6B are an improvement over conventional approaches as conventional approaches solely concentrate on the send methods 608. Further, the rules for creating the linked list of FIG. 6B are an improvement over creating all linked lists in that the issue is not capturing the tracking information but rather in simplifying the captured data. Complex websites can result in millions of connected elements which are then combined into the linked lists. Attempting to filter hundreds of thousands of linked lists to determine which particular linked list is improperly tracking a user's actions is error-prone and often futile. However, applying the described unconventional rules of creating linked lists and using only those linked lists that include the send methods 608 reduces the total quantity of linked lists to be reviewed. For instance, for complex websites that leak significant quantities of user information, it is expected that most linked lists are problematic—meaning that any given linked list has a higher percentage of leaking user data. In contrast, for well-managed websites with few leaks of user data, finding those few leaks in the linked lists of hundreds of thousands of linked lists significantly reduces the probability of any given linked list being the problematic chain of methods. Accordingly, the unconventional approach of reviewing linked lists backward in time is expected to increase the throughput of data processing systems analyzing the linked list of methods.

### Identifying Tracking of User Information in Mobile Applications

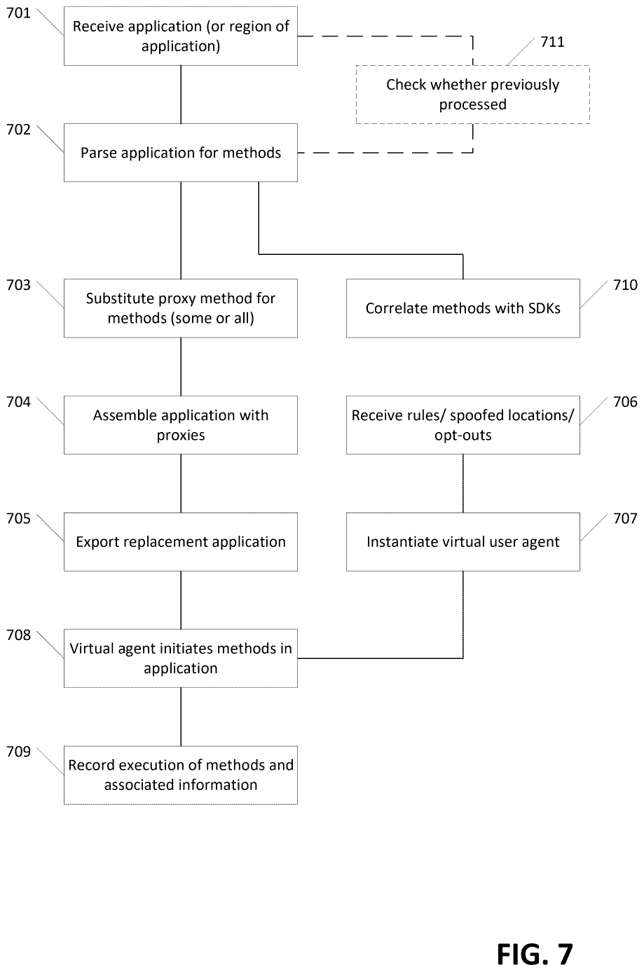

FIG. 7 is a process for replacing methods of a mobile application with proxy versions of the methods, interacting with the modified mobile application, and recording the execution of the proxy methods. Mobile applications are more complex to analyze for data leakage as third-party SDK providers are not as constrained in the types of methods used to record, store, and send data out of the applications. As described below, one or more aspects of the monitoring of third-party methods of mobile applications include replacing third-party methods with proxy versions of those methods. Those proxy versions allow the monitoring system to determine when a third-party method operates, which third-party method is operating, and the data elements related to the executed third-party methods.

In step 701, an application is received. The full application may be received or just a portion of the application to be reviewed. In some examples, the application may be an uncompiled test version of the application. In other examples, the application may be compiled to the extent that the methods executing in the application may be determined. The process may be executed on a provider server and/or in a server separate from the provider. In step 702, the application is parsed for SDKs used in the application. The parsing of the application may include de-compiling the mobile application into a representative source code. The identified SDKs are further processed to extract relevant methods, data elements, and relationships between the data elements and methods. In step 710, the methods are correlated with the SDKs and the third-party entities providing the SDKs. Also, the methods may be aggregated by third-party domains.

In step 703, the methods are replaced with proxy methods. Some or all of the methods may be replaced with the proxy methods. In step 704, the application is reassembled with the proxy methods into an executable version of the application. In step 705, the replacement application is exported in step 705. In step 706, the system receives rules/spoofed locations/opt-out instructions, browser types to test, and the like. In step 707, the system instantiates a virtual user agent to execute the replacement application. In step 708, the virtual user agent interacts with the application by entering data and/or navigating to various parts of the application. In step 709, the system records the execution of the methods and associated information (e.g., where in the application the method is initiated, the data elements that initiate the method, the result of the method, and the like. In step 711, the system may optionally determine whether the application or portion of the application has been previously reviewed similar to the fingerprint identification of FIG. 5.

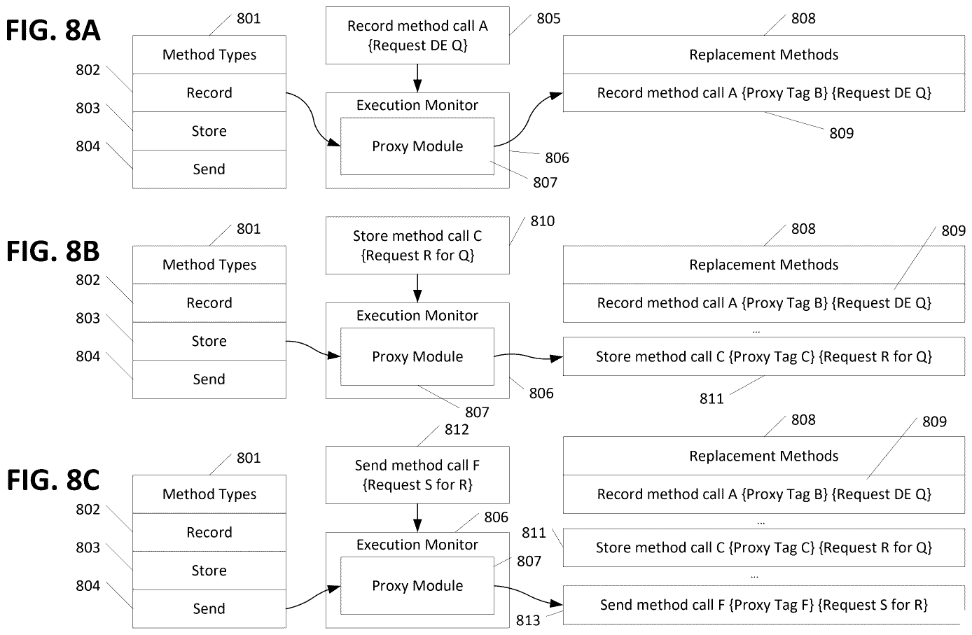

FIGS. 8A, 8B, and 8C represent a proxy module replacing methods with proxy versions of the methods. Table 801 identifies third-party method types. The method types include for example, a recording method type 802 that records the user interaction with a data element, a storing method type 803 that stores the information recorded from recording method type 802, and a send method type 804 that sends the information stored by method type 803. The list of method types 801 is a sample list. Other method types may be included in place of or in addition to method types 802-804. A record method call A is shown as method 805. The record method call A 805 includes, as its payload, a request for information relating to data element (DE) Q.

FIG. 8A includes an execution monitor process 806 that replaces method types with proxy versions of the method types. In one or more examples, the replacement process may be represented by a proxy module 807. The proxy module 807 may include one or more tags for the method types 801 and replace the third-party method with a proxy version of the third-party method. In FIG. 8A, the third-party record method call A, with the request for data element Q, is replaced by a record method call A with proxy tag B. The requested data element Q remains part of the replacement method. For instance, the proxy module 807 of execution monitor 806 retrieves from method types 801 information for a recording method type 802 how to replace the record method call 805 A with a proxy version of the record method. Next, the proxy module 807 replaces the record method call A 805 with a proxy version 809 of the record method call A 805. The list of replacement methods is identified in table 801 with the new proxy record method identified as method 809.

In FIG. 8B, the execution monitor 806 receives a store method call C 810 with a request to store, as information R, the recorded information from data element Q. The execution monitor 806 executes the proxy module 807. The proxy module 807 of execution monitor 806 retrieves from method types 801 information for store method type 803 how to replace the store method C 810 with a proxy version of the send method. Next, the proxy module 807 replaces the store method call C with a proxy version 811 of the store method call C 810. The proxy version 811 includes, for instance, a proxy tag C in addition to the payload of the store call (e.g., to store as information R the information received from data element Q). As shown in FIG. 8B, the replacement proxy version 811 is added to the table of replacement methods 808. The replacement proxy version 811 may be appended immediately after the proxy version 809 of the record method call or after additional methods.

In FIG. 8C, a send method call F, including a request to send S the stored information R relating to data element Q, is received by the execution monitor 806. The proxy module 807 of execution monitor 806 retrieves from method types 801 information for send method type 804 how to replace the send method 812 with a proxy version of the send method. Next, the proxy module 807 replaces the send method call F with a replacement proxy method call 813 of the send method call F. The proxy method call 813 includes a proxy tag F and the original payload from the send method call F 812. The proxy method call 813 is appended to the replacement methods 808. The proxy method call 813 may be appended directly after the proxy version 811 of the stored method call C or may be appended after other proxy methods.

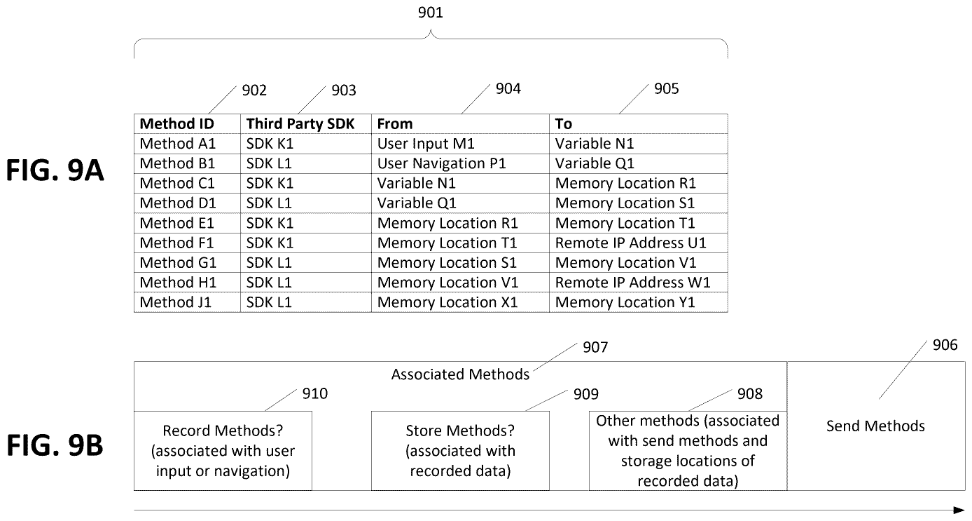

FIG. 9A is a dataset of monitored proxy methods executing in a mobile application. FIG. 9A includes a list 901 with method identifications column 902, third-party SDK column 903, a From column 904 identifying the data element that invoked the method, and a To column 905 identifying the output of the method. As shown in FIG. 9A, method A1 is associated with SDK K1 and is invoked based on the virtual user agent entering data into the user input field M1. The output of method A1 is to record the data of user input field M1 into variable N1. Method B1 is associated with SDK L1 and is invoked based on the virtual user agent navigating the application (identified as user navigation P1). The output of method B1 is to record the user navigation P1 into variable Q1. Method C1 is associated with SDK K1 and is invoked based on the existence of data in variable N1. The output of method C1 stores data (whether it is the same as or different from variable N1) into memory location R1. Method D1 is associated with SDK L1 and is invoked based on data appearing in variable Q1. The output of method D1 stores data in memory location S1. Method E1 is associated with SDK K1 and is invoked when data is present in memory location R1. The output of method E1 is to store data in memory location T1. Method F1 is associated with SDK K1 and is invoked based on data present in memory location T1. The output of method F1 is to send the data of memory location T1 to remote IP address U1.

Method G1 is associated with SDK K1 and is invoked based on data being present in memory location S1. The output of method G1 is to store data at memory location V1. Method H1 is associated with SDK L1 and is invoked based on the existence of data at memory location V1. The output of method H1 is to send data to remote IP address W1. Method J1 is associated with SDK L1 and is invoked based on data appearing in memory location X1. The output of method J1 is to write data to memory location Y1.

The data from list 901 may be combined into a linked list. FIG. 9B shows an example of the linked list. The methods that send data to a remote IP address are collectively identified as send methods 906. The methods executing in the mobile app may be record methods, send methods, combinations of record and send methods, or other methods, the linked list of methods of FIG. 9B relates the methods together based on their related data elements. Preceding send methods 906 are associated methods 907. The associated methods 907 may include other methods 908, possible store methods 909, and possible record methods 910. The

The relative importance of the associated methods 907 and the send methods 906 is based on the closeness a method is to the end of the linked lists. In particular, the third-party methods are relevant primarily because of tracking of user data. While the third-party methods may record and store user data, the relevance of that tracking is limited where the user data is never sent out of the system. In effect, the third-party methods may be effectively policing themselves where no user data is being sent to a remote IP address. However, concentrating solely on the send methods fails to account for what specific user data is being sent. Accordingly, the linked lists of FIG. 9B may be analyzed starting with the send methods 906 and tracing the upstream methods (associated methods 907) to the relevant user information being tracked in column 904.

The rules creating the linked list of FIG. 9B are an improvement over conventional approaches as conventional approaches solely concentrate on the send methods 906. Further, the rules for creating the linked list of FIG. 9B are an improvement over creating all linked lists in that the issue is not capturing the tracking information but rather in simplifying the captured data. Complex websites can result in millions of connected elements which are then combined into the linked lists. Attempting to filter hundreds of thousands of linked lists to determine which particular linked list is improperly tracking a user's actions is error-prone and often futile. But applying the described unconventional rules of creating linked lists and using only those linked lists that actually include send methods 906 reduces the total quantity of linked lists to be reviewed. For instance, for complex websites that leak significant quantities of user information, it is expected that most linked lists are problematic—meaning that any given linked list has a higher percentage of leaking user data. In contrast, for well-managed websites with few leaks of user data, finding those few leaks in the linked lists of hundreds of thousands of linked lists significantly reduces the probability of any given linked list being the problematic chain of methods. Accordingly, the unconventional approach of reviewing linked lists backward in time is expected to increase the throughput of data processing systems analyzing the linked list of methods.

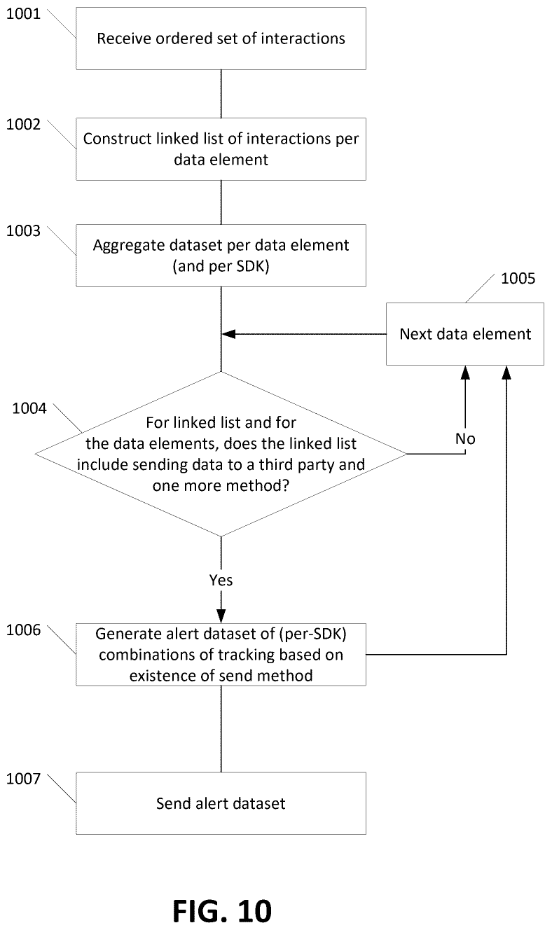

FIG. 10 is a process for analyzing a nested set of aggregated results. In step 1001, the process receives the ordered set of interactions of FIG. 6A or 9A. In step 1002, a linked list of interactions per data element on web pages and/or in applications is constructed by the process. For reference, the process of FIG. 10 may execute in the provider server 304 and/or in another server separate from the provider server 304. In step 1003, the process aggregates one or more datasets where each dataset may identify particular data elements and the third-party domains associated with the third-party method calls. The third-party domains may be based on the matching of the method calls with the list of known names of domains or SDKs (from step 710). In step 1004, the process determines, for data elements and per third-party domain, whether the combination of third-party method calls includes two or more third-party method call processes. If for a given data element third-party method calls did not include two or more of the identified interactions from step 1004, the process repeats for the next data element 1005. If two or more interactions per data element or identified from step 1004, the process generates an alert dataset, in step 1006. The alert may include the domains and data elements. The process is repeated for all data elements via step 1005 identified in the ordered set of interactions of step 1001. After all data elements 1005 have been filtered via step 1004, an aggregated dataset of the interactions per data element is sent in step 1007. The sending of the aggregated dataset from step 1007 may include storage of each identified data element and the interactions together before sending the aggregated dataset. Additionally or alternatively, the sending of the aggregated dataset in step 1007 may include streaming the filtered interactions with the data elements as they occur.

FIG. 11 is a diagram of methods available on one or more web pages. FIG. 11 shows an example of data elements in a web page or application as reflected in a tree 1101 providing relationships between the data elements. The tree 1101 may be used to identify the data elements an instantiated virtual agent is to interact with (e.g., across web pages and/or in a mobile application). Additionally or alternatively, the tree 1101 in combination with highlighted data elements from a provider may be used to restrict the interactions of the virtual agent with particular data elements on a given page or across various web pages or particular data elements in a mobile application.

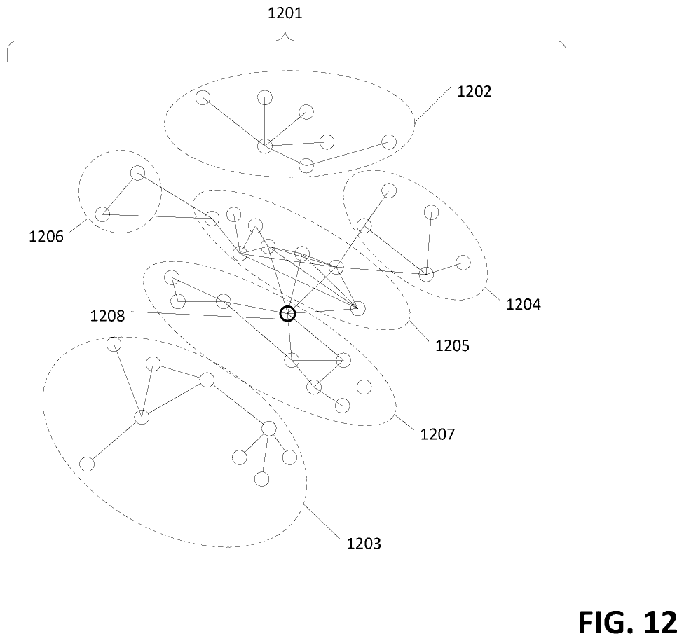

FIG. 12 is a network diagram of data being shared by third parties based on connections between methods. The network diagram 1201 includes a plurality of nodes representing methods, the data shared by the methods as edges, and third parties by the dashed lines. FIG. 12 includes third parties 1202, 1203, 1204, 1205, 1206, and 1207. Third parties 1205 and 1207 are closely associated with each other as multiple data elements are shared between the third parties.

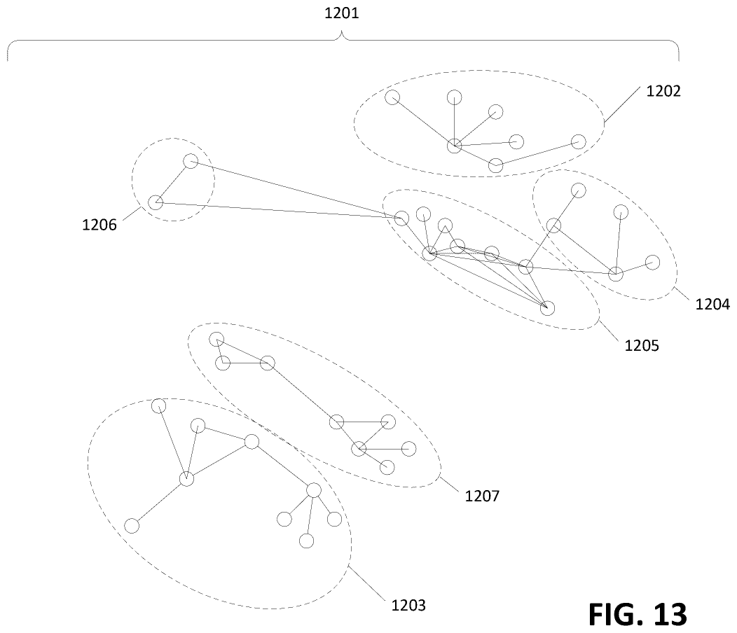

FIG. 13 is a network diagram of data being shared by third parties with less linking of data. In FIG. 13, the method node 1208 of FIG. 12 was removed from the web pages/application and the data elements linked to the node are no longer connecting the two third parties 1205 and 1207. The resulting network diagram of FIG. 13 is more spaced out than the tighter network diagram of FIG. 12.

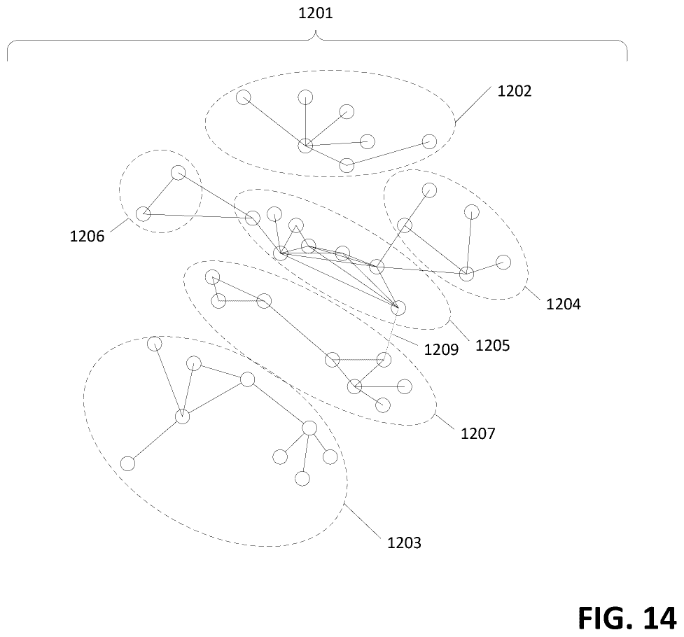

FIG. 14 is a network diagram of data being shared by third parties despite the removal of some of the links present in FIG. 12.

### Embodiments

In one or more embodiments, a method may comprise receiving, from a storage, a network-connected software application; parsing the network-connected software application for methods and associated data elements; replacing the methods with proxy versions of the methods; assembling, based on the proxy versions of the methods, a replacement network-connected software application; instantiating, at a server, a virtual user agent configured to interact with data elements; interacting, via the virtual user agent, with the associated data elements of the replacement network-connected software application; receiving, based on the virtual user agent interacting with the associated data elements, notifications of execution of the proxy versions of the methods; storing the notifications including identifications of the proxy versions of the methods, data elements acted upon by the executed proxy versions of the methods, and results of the executed proxy versions of the methods; assembling, based on the stored notifications and the data elements, linked lists of the executed proxy versions of the methods, wherein at least some of the linked lists comprise sending associated data elements to a remote server; and generating, based on the linked lists, an alert for the network-connected software application with associated data elements sent to the remote server.

The network-connected software application comprises sections. The notifications may include identifications of the sections in which the proxy versions of the methods were executed. The generation of the alert may be based on the identification of the sections of the associated data elements.

The identification of the at least one of the sections may be less than all of the sections. The generation of the alert may be limited to the identified sections.

The alert may be segregated by third-party software development kits (SDKs).

The method may further include receiving a threshold, per section, of a quantity of data elements read per section. The generation of the alert may further include counting, per section, the quantity of associated data elements sent to the remote server; and determining, based on the counting, the quantity of associated data elements sent to the remote server satisfies the threshold.

The interaction may include specifying a geographic location and generating the alert based on the geographic location.

The method may further include instantiating, at the server, a second virtual user agent configured to interact with the data elements, wherein the second virtual user agent specifies a second geographic location; and interacting, via the second virtual user agent, with the associated data elements of the replacement network-connected software application, with the generating the alert being based on the second geographic location.

The method of generating the alert may further comprise generating an alert data set by arranging the interactions into an ordered list of interactions and outputting the ordered list of interactions as a JavaScript Object Notation (JSON) file.

A first data element of the data elements may include an opt-out data element. The interaction with the associated data elements of the replacement network-connected software application may include causing the virtual user agent to modify a state of the opt-out data element. The generation of the alert may be further based on the modification of the state of the opt-out data element and subsequent notifications of executions of the proxy versions of the methods.

An apparatus according to various embodiments may include one or more processors; and memory storing instructions that, when executed by the one or more processors, cause the apparatus to receive, from a storage, a network-connected software application; parse the network-connected software application for methods and associated data elements; replace the methods with proxy versions of the methods; assemble, based on the proxy versions of the methods, a replacement network-connected software application; instantiate, via the one or more processors, a virtual user agent configured to interact with data elements; interact, via the virtual user agent, with the associated data elements of the replacement network-connected software application; receive, based on the virtual user agent interacting with the associated data elements, notifications of execution of the proxy versions of the methods; store the notifications including identifications of the proxy versions of the methods, data elements acted upon by the executed proxy versions of the methods, and results of the executed proxy versions of the methods; assemble, based on the stored notifications and the data elements, linked lists of the executed proxy versions of the methods, wherein at least some of the linked lists comprise sending associated data elements to a remote server; and generate, based on the linked lists, an alert for the network-connected software application with associated data elements sent to the remote server.

The network-connected software application may include sections. The notifications may include identifications of the sections in which the proxy versions of the methods were executed. The instructions to generate the alert may be further based on the identification of the sections of the associated data elements. The identification of the at least one of the sections may be less than all of the sections and the alert limited to the identified sections. The alert may be further segregated by third-party software development kits (SDKs).

The instructions may further cause the apparatus to receive a threshold, per section, of a quantity of data elements, read per section. The alert may be based on counting per section, the quantity of associated data elements sent to the remote server, and determining the quantity of associated data elements sent to the remote server satisfies the threshold.

The virtual user agent may specify a geographic location. The alert may be based on the geographic location. The instructions may further cause the apparatus to instantiate a second virtual user agent configured to interact with the data elements, wherein the second virtual user agent specifies a second geographic location; and interacts, via the second virtual user agent, with the associated data elements of the replacement network-connected software application. The alert may be based on the second geographic location.

The instructions to generate the alert may further arrange the interactions into an ordered list of interactions; and output the ordered list of interactions as a JavaScript Object Notation (JSON) file. A first data element of the data elements may include an opt-out data element. The instructions to interact with the associated data elements of the replacement network-connected software application further cause the apparatus to cause the virtual user agent to modify a state of the opt-out data element. The alert may be based on the modification of the state of the opt-out data element and subsequent notifications of executions of the proxy versions of the methods.

In one or more embodiments, one or more non-transitory media may store instructions that, when executed by one or more processors, cause the one or more processors to perform steps including receiving, from a storage, a network-connected software application; parsing the network-connected software application for methods and associated data elements; replacing the methods with proxy versions of the methods; assembling, based on the proxy versions of the methods, a replacement network-connected software application; instantiating a virtual user agent configured to interact with data elements; interacting, via the virtual user agent, with the associated data elements of the replacement network-connected software application; receiving, based on the virtual user agent interacting with the associated data elements, notifications of execution of the proxy versions of the methods; storing the notifications including identifications of the proxy versions of the methods, data elements acted upon by the executed proxy versions of the methods, and results of the executed proxy versions of the methods; assembling, based on the stored notifications and the data elements, linked lists of the executed proxy versions of the methods, wherein at least some of the linked lists may include sending associated data elements to a remote server; and generating, based on the linked lists, an alert for the network-connected software application with associated data elements sent to the remote server.

The network-connected software application may include sections, wherein the notifications may include identifications of the sections in which the proxy versions of the methods were executed. The alert may be further based on the identification of the sections of the associated data elements.

Aspects of the disclosure are described herein in terms of illustrative embodiments thereof. Numerous other embodiments, modifications, and variations within the scope and spirit of the recited disclosure will occur to persons of ordinary skill in the art from a review of this disclosure. For example, one of ordinary skill in the art will appreciate that the steps illustrated in the illustrative figures and described herein may be performed in other than the recited order and that one or more illustrative steps may be optional in accordance with aspects of the invention.

1. A method comprising:
receiving, from a storage, a network-connected software application;
parsing the network-connected software application for methods and associated data elements;
replacing the methods with proxy versions of the methods;
assembling, based on the proxy versions of the methods, a replacement network-connected software application;
instantiating, at a server, a virtual user agent configured to interact with data elements;
interacting, via the virtual user agent, with the associated data elements of the replacement network-connected software application;
receiving, based on the virtual user agent interacting with the associated data elements, notifications of execution of the proxy versions of the methods;
storing the notifications including identifications of the proxy versions of the methods, data elements acted upon by the executed proxy versions of the methods, and results of the executed proxy versions of the methods;
assembling, based on the stored notifications and the data elements, linked lists of the executed proxy versions of the methods, wherein at least some of the linked lists comprise sending associated data elements to a remote server; and
generating, based on the linked lists, an alert for the network-connected software application with associated data elements sent to the remote server.

2. The method of claim 1,
wherein the network-connected software application comprises sections,
wherein the notifications comprise identifications of the sections in which the proxy versions of the methods were executed,
wherein the generating the alert is further based on the identification of the sections of the associated data elements.

3. The method of claim 2,
wherein the identification of the at least one of the sections is less than all of the sections, and
wherein the generating the alert is further limited to the identified sections.

4. The method of claim 1,
wherein the generating the alert is further segregated by third-party software development kits (SDKs).

5. The method of claim 2, further comprising:
receiving a threshold, per section, of a quantity of data elements read per section,
wherein the generating the alert comprises:
counting, per section, the quantity of associated data elements sent to the remote server; and
determining, based on the counting, the quantity of associated data elements sent to the remote server satisfies the threshold.

6. The method of claim 1, wherein the interacting comprises:
specifying a geographic location; and
wherein the generating the alert is further based on the geographic location.

7. The method of claim 6, further comprising:
instantiating, at the server, a second virtual user agent configured to interact with the data elements, wherein the second virtual user agent specifies a second geographic location; and
interacting, via the second virtual user agent, with the associated data elements of the replacement network-connected software application,
wherein the generating the alert is further based on the second geographic location.

8. The method of claim 1, wherein the generating the alert comprises generating an alert data set comprising:
arranging the interactions into an ordered list of interactions; and
outputting the ordered list of interactions as a JavaScript Object Notation (JSON) file.

9. The method of claim 1,
wherein a first data element of the data elements comprises an opt-out data element,
wherein the interacting with the associated data elements of the replacement network-connected software application comprises:
causing the virtual user agent to modify a state of the opt-out data element, and
wherein the generating the alert is further based on the modification of the state of the opt-out data element and subsequent notifications of executions of the proxy versions of the methods.

10. An apparatus comprising:
one or more processors; and
memory storing instructions that, when executed by the one or more processors, cause the apparatus to:
receive, from a storage, a network-connected software application;
parse the network-connected software application for methods and associated data elements;
replace the methods with proxy versions of the methods;
assemble, based on the proxy versions of the methods, a replacement network-connected software application;
instantiate, via the one or more processors, a virtual user agent configured to interact with data elements;
interact, via the virtual user agent, with the associated data elements of the replacement network-connected software application;
receive, based on the virtual user agent interacting with the associated data elements, notifications of execution of the proxy versions of the methods;
store the notifications including identifications of the proxy versions of the methods, data elements acted upon by the executed proxy versions of the methods, and results of the executed proxy versions of the methods;
assemble, based on the stored notifications and the data elements, linked lists of the executed proxy versions of the methods, wherein at least some of the linked lists comprise sending associated data elements to a remote server; and
generate, based on the linked lists, an alert for the network-connected software application with associated data elements sent to the remote server.

11. The apparatus of claim 10,
wherein the network-connected software application comprises sections,
wherein the notifications comprise identifications of the sections in which the proxy versions of the methods were executed, and
wherein the instructions to generate the alert are further based on the identification of the sections of the associated data elements.

12. The apparatus of claim 11,
wherein the identification of the at least one of the sections is less than all of the sections, and
wherein the instructions to generate the alert are further limited to the identified sections.

13. The apparatus of claim 10,
wherein the instructions to generate the alert are further segregated by third-party software development kits (SDKs).

14. The apparatus of claim 11,
wherein the instructions further cause the apparatus to receive a threshold, per section, of a quantity of data elements read per section, and
wherein the instructions to generate the alert further cause the apparatus to:
count, per section, the quantity of associated data elements sent to the remote server; and
determine, based on the counting, the quantity of associated data elements sent to the remote server satisfies the threshold.

15. The apparatus of claim 10,
wherein the instructions instantiate the virtual user agent specify a geographic location, and
wherein the instructions to generate the alert are further based on the geographic location.

16. The apparatus of claim 15, wherein the instructions further cause the apparatus to:
instantiate a second virtual user agent configured to interact with the data elements, wherein the second virtual user agent specifies a second geographic location; and
interact, via the second virtual user agent, with the associated data elements of the replacement network-connected software application,
wherein the instructions to generate the alert are further based on the second geographic location.

17. The apparatus of claim 10, wherein the instructions to generate the alert further cause the apparatus to:
arrange the interactions into an ordered list of interactions; and
output the ordered list of interactions as a JavaScript Object Notation (JSON) file.

18. The apparatus of claim 10,
wherein a first data element of the data elements comprises an opt-out data element,
wherein the instructions to interact with the associated data elements of the replacement network-connected software application further cause the apparatus to:
cause the virtual user agent to modify a state of the opt-out data element, and
wherein the instructions to generate the alert are further based on the modification of the state of the opt-out data element and subsequent notifications of executions of the proxy versions of the methods.

19. One or more non-transitory media storing instructions that, when executed by one or more processors, cause the one or more processors to perform steps comprising:
receiving, from a storage, a network-connected software application;
parsing the network-connected software application for methods and associated data elements;
replacing the methods with proxy versions of the methods;
assembling, based on the proxy versions of the methods, a replacement network-connected software application;
instantiating, at a server, a virtual user agent configured to interact with data elements;
interacting, via the virtual user agent, with the associated data elements of the replacement network-connected software application;
receiving, based on the virtual user agent interacting with the associated data elements, notifications of execution of the proxy versions of the methods;
storing the notifications including identifications of the proxy versions of the methods, data elements acted upon by the executed proxy versions of the methods, and results of the executed proxy versions of the methods;
assembling, based on the stored notifications and the data elements, linked lists of the executed proxy versions of the methods, wherein at least some of the linked lists comprise sending associated data elements to a remote server; and
generating, based on the linked lists, an alert for the network-connected software application with associated data elements sent to the remote server.

20. The one or more non-transitory media of claim 19,
wherein the network-connected software application comprises sections,
wherein the notifications comprise identifications of the sections in which the proxy versions of the methods were executed, and
wherein the generating the alert is further based on the identification of the sections of the associated data elements.
